(19) United States
(12) Patent Application Publication
(10) Pub. No.: US 2002/0193107 A1
(43) Pub. Date: Dec. 19, 2002

(54) Wireless/wireline communication

(76) Inventor: Oswaldo L. do Nascimento JR., Wellesley, MA (US)

Correspondence Address: Shane H. Hunter, Mintz, Levin, Cohn, Ferris,, Glovsky and Popeo, P.C., One Financial Center, Boston, MA, 02111, US

(21) Appl. No.: 10/077,524

(22) Filed: Feb. 15, 2002

Related U.S. Application Data
(60) Provisional application No. 60/295,774, filed on Jun. 4, 2001.
(60) Provisional application No. 60/302,473, filed on Jul. 2, 2001.

(51) Int. Cl. H04Q 7/20

(52) U.S. Cl. 455/426; 455/406; 455/74.1

(57) ABSTRACT

A switching system for coupling a telecommunications device to a wireless network or a wireline network includes a wireless telecommunication interface configured to couple to a wireless telecommunications device configured to transfer data to and from a wireless telecommunications network, a wireline phone interface configured to couple to a wireline-network phone, a wireline network interface configured to couple to a wireline phone network, a switching mechanism configured to selectively couple the wireline-network phone interface to the wireless telecommunication interface or to the wireline network interface, and a controller coupled to the switching mechanism and configured to control the selective coupling effected by the switching mechanism.

### FIELD OF THE INVENTION

The invention relates to telecommunication and more particularly to wireless and wireline communication.

### BACKGROUND OF THE INVENTION

Telecommunications technology has advanced dramatically in recent history. People now use forms of communication that did not exist, or were not readily accessible (e.g., financially), such as email, cellular or other mobile phones, pagers, and personal digital assistants (PDAs) that include communications features such as instant messaging. These technologies have become more widespread, easy to use, affordable, and perceived as convenient if not a necessary part of modern life.

Many people use multiple types of telecommunications, often on a daily basis. For example, many people use cellular or other mobile phones in place of wireline phones, or while they are away from wireline phones. People often use mobile phones while they are in transit to and from work, e.g., in cars and on trains. People typically use wireline phones for communication when they are at their place of business, e.g., at a desk, or in their homes.

With the proliferation of telecommunications devices, and deregulation of phone services, have come a variety of rate schedules for different types of communication, and competing suppliers of similar communication types. For example, there are many rate plans for mobile phones, some including “free” minutes that are included as part of a base cost, e.g., on a monthly basis, and different minutely rates depending on the base cost, where a call is made from and to where it is directed relative to regions associated with the plan, time of day, and day of week. Wireline communications also have associated rate plans that vary widely depending, e.g., on base cost, minutes per period (e.g., month), destination of a call (particularly whether the call is domestic or international), time of day, and day of week. Other factors may also influence the cost of any particular call, be it wireline or wireless.

### SUMMARY OF THE INVENTION

In general, in an aspect, the invention provides a switching system for coupling a telecommunications device to a wireless network or a wireline network. The system includes a wireless telecommunication interface configured to couple to a wireless telecommunications device configured to transfer data to and from a wireless telecommunications network, a wireline phone interface configured to couple to a wireline-network phone, a wireline network interface configured to couple to a wireline phone network, a switching mechanism configured to selectively couple the wireline-network phone interface to the wireless telecommunication interface or to the wireline network interface, and a controller coupled to the switching mechanism and configured to control the selective coupling effected by the switching mechanism.

Implementations of the invention may include one or more of the following features. The controller is configured to control the switching mechanism in accordance with at least one of a wireless rate structure associated with the wireless telecommunication device and a wireline rate structure associated with the wireline phone network. The controller is configured to control the selective coupling of the switching mechanism depending on which coupling will likely yield a cheaper effective rate for a call being sent from the wireline-network phone. The controller is configured to control the selective coupling of the switching mechanism depending on at least one of instantaneous rates associated with the wireless telecommunications device and the wireline-network phone, whether the call is local or long distance, to where the call is directed, the rate structures, typical amounts of call minutes from the wireless telecommunication device, and typical amounts of call minutes from the wireline-network phone. The rate structures are affected by at least one of amounts of free minutes, time of day, and day of week. The effective rate for a call is a present rate. The effective rate for a call is an average rate.

Also, implementations of the invention may include one or more of the following features. The system further includes another wireless telecommunication interface configured to couple to another wireless telecommunications device, wherein the switching mechanism is configured to selectively couple the wireline phone interface to the wireless telecommunication interface, the another wireless telecommunication interface, or to the wireline network interface. The system further includes at least another wireline phone interface configured to couple to another wireline-network phone, wherein the switching mechanism is configured to selectively couple the wireline phone interface or the at least another wireline phone interface to the wireless telecommunication interface or to the wireline network interface. The at least another wireline phone interface comprises seven wireline phone interfaces. The system further includes another wireline network interface configured to couple to the wireline phone network, wherein the switching mechanism is configured to selectively couple the wireline phone interface to the wireless telecommunication interface, to the wireline network interface, or to the another wireline network interface. The wireline phone interface is a first wireline phone interface, and the wireline network interface is a first wireline network interface, the system further including multiple second wireline phone interfaces configured to couple to a plurality of wireline-network phones, and a second wireline network interface configured to couple to the wireline phone network, wherein the switching mechanism is configured to selectively couple at least one of the second wireline phone interfaces to the second wireline network interface.

Also, implementations of the invention may include one or more of the following features. The wireless telecommunication interface is configured to wirelessly couple to the wireless telecommunications device. The wireless telecommunication interface is configured to wirelessly communicate with the wireless telecommunications device according to a short-range wireless communication protocol. The wireless protocol is the Bluetooth® protocol. The system further includes an inter-system communication interface configured to couple to and communicate with another switching system as recited in claim 1 and further including another inter-system communication interface. The wireless telecommunications device is a mobile phone.

In general, in an aspect, the invention provides a method of providing mobile communication service. The method includes providing wireless communication capacity for a wireless communication device, the communication capacity associated with a first rate structure for communication with the wireless communication device, determining that the wireless communication device is near a stationary base unit configured to communicate with the wireless device, and adjusting the rate structure associated with the wireless device to a second rate structure that is different than the first rate structure.

Implementations of the invention may include one or more of the following features. The determining includes receiving an indication of proximity of the wireless device to the relatively-stationary base unit from the base unit. The determining includes receiving an indication of proximity of the wireless device to the relatively-stationary base unit from the wireless device. The second rate structure more closely resembles a rate structure associated with a wireline service rate structure than the first rate structure. The method further includes redirecting a call coming into the wireless device through a wireline network to a wireline phone connected to the base unit.

In general, in an aspect, the invention provides a system for coupling a wireline phone to a mobile-phone network. The system includes a mobile-phone interface configured to couple to a mobile phone and to transfer information between the mobile-phone interface and the mobile phone according to a mobile-phone protocol, and a wireline-phone interface coupled to the mobile-phone interface and configured to couple to a wireline-network phone and to transfer information between the wireline-phone interface and the wireline-network phone according to a wireline-phone protocol, whereby a call can be made from the wireline-network phone connected to the wireline-interface through a mobile-phone network associated with the mobile phone connected to the mobile-phone interface.

Implementations of the invention may include one or more of the following features. The system further includes a mobile phone coupled to the mobile-phone interface, and a wireline phone coupled to the wireline-phone interface.

In general, in an aspect, the invention provides a telephone interface system capable of coupling to a plurality of wireline telephone extensions independently, capable of coupling to a wireline telecommunications network through a plurality of independent connections, and capable of independently coupling to a plurality of mobile telephones associated with at least one mobile-phone network, the system providing connection capability for calls to be completed between wireline extensions through the system, and the system providing connection capability for calls to be completed through the system between a wireline extension connected to the system and at least one of the mobile telephones connected to the system.

Implementations of the invention may include one or more of the following features. The system is capable of coupling to at least one of the mobile phones wirelessly. The system is capable of coupling to at least one of the mobile phones wirelessly in accordance with a short-range wireless protocol. The system is further configured to selectively couple at least one wireline extension to at least one of the wireline network and at least one mobile telephone. The system is further configured to couple to another system according to the preceding paragraph. This system is configured to be capable of coupling a connection from the system to an extension, the wireline telecommunications network, or a mobile telephone, through the another system to an extension, a wireline telecommunications network, or a mobile telephone coupled to the another system.

Various aspects of the invention may provide one or more of the following advantages. Mobile communication providers can compete more effectively with wireline telephone service providers. A wireline phone may be used to place or receive calls through a mobile-phone network. Phone users may take advantage of competitive rates between wireline and wireless services. Mobile phones may be answered at a standard wireline telephone to which the phones are both connected. Missed calls due to, e.g., timeouts or a person not hearing a phone ring, may be reduced. Mobile phones may be charged while connected to a system providing other features.

These and other advantages of the invention, along with the invention itself, will be more fully understood after a review of the following figures, detailed description, and claims.

### BRIEF DESCRIPTION OF THE FIGURES

FIG. 1 is a diagram of a wireless home loop system connected to four standard telephones connected in parallel on a single extension, and a mobile telephone via a wireless trunk line.

FIG. 2 is a diagram of a wireless home loop system connected to eight standard telephones connected in parallel groups of four each on two extensions, a PSTN trunk line, and a mobile telephone through a wireless trunk line.

FIG. 3 is diagram of a wireless home loop system connected to eight standard telephones, four data terminals, a mobile telephone through a wireless trunk line, and a PSTN trunk line.

FIG. 4 is a diagram of a wireless home loop system connected to eight standard telephone extensions, two mobile telephones, and two PSTN trunk lines.

FIG. 5 is a diagram of three wireless home loop systems, connected to each other to form a larger system, connected to 24 standard telephones, six PSTN trunk lines, and wirelessly connected to six mobile telephones.

FIG. 6 is a simplified generic block diagram of a hardware-modules architecture of a wireless home loop system.

FIG. 7 is a more-detailed block diagram of the hardware architecture shown in FIG. 6, corresponding to the wireless home loop system shown in FIG. 1.

FIG. 8 is a block diagram of a hardware architecture of the wireless home loop system shown in FIG. 2.

FIG. 9 is a simplified block diagram of a software architecture for wireless home loop systems.

FIG. 10 is a block diagram of a hardware architecture of the wireless home loop system shown in FIG. 4.

FIG. 11 is a block diagram of a hardware architecture of the wireless home loop system shown in FIG. 5.

FIG. 12 is a block diagram of a hardware architecture of the wireless home loop system shown in FIG. 3.

FIG. 13 is a block flow diagram of a process of using a wireless home loop system and associated devices.

### DETAILED DESCRIPTION OF PREFERRED EMBODIMENTS

A system is provided that connects to both wireless and wireline phone networks. The system receives a wireless phone, either by hard-wired connection or wireless connection (e.g., using Bluetooth® technology). Using any hard-wired standard phone extension or data terminal (e.g., a computer) connected to the system, a user can place calls and connect to a data network via the wireless or wireline phone networks. The user can select which network to use, or the system can make a choice as to which network to use for a particular call or connection.

To make the choice to use the wireline or the wireless network for an outgoing call or connection, the system can account for a variety of factors. These factors include: whether the call is local or long distance; if long distance, to where specifically is the call directed; the rate plans of the wireless and wireline networks for the system/user, this can include amounts of free minutes, time of day, day of week, typical amounts of call minutes per month (e.g., a network may be preferred even if the current rate is higher than the other network's current rate if there is a price break for more minutes such that the average for the month will make using the selected network for the current call cheaper than using the other network's current rate). The system is scalable to multiple wireless connections and multiple wireline connections and extensions.

Also, using the system, the wireless network may use information that the wireless handset is connected to the system and is therefore, e.g., at home, or another relatively fixed position, to provide a different rate and/or rate plan/structure. For example, a cheaper rate may be provided given that the handset will not require expenses incurred in servicing a handset that is mobile/on the move, e.g., requiring handoff between cells in a cellular network. The system can adapt for such rate schedule adjustments.

Referring to FIG. 1, a system 10 includes a wireless home loop (WHL) system 12, a wireless mobile phone 14, and up to four standard telephones 16₁-16₄. The WHL, although having “home” in its name, is not limited to use in a home (e.g., use in an office is possible). The mobile phone 14 may be any of a variety of types of mobile phones, such as a cellular phone, and is connected to the WHL 12 with a wire. The mobile phone 14 may also be other types of wireless telecommunications devices such as Personal Digital Assistants (PDAs) or hand-held computers with wireless communications functionality. The wireline phones 16₁-16₄ are analog phones connected in parallel to the WHL 12. Although four wireline phones 16₁-16₄ are shown, other numbers of wireline phones, e.g., one or two, can be used in the system 10. The mobile phone 14 performs as a regular mobile phone when not connected to the WHL 12, with regular charges/costs and advantages (e.g., mobility, roaming). While connected to the WHL 12, the mobile phone 14 may take on characteristics of a wireline phone.

The WHL 12 is a voice and data communication system. With a wireless device connected to the WHL 12, the WHL 12 can provide access to a wireless network through the use of standard telephone sets and data terminals, e.g., installed inside a house or an office. Wireless devices connected to the WHL 12 preferably operate in the frequency bands used for Cellular and/or PCS (personal communication system) communication. Wireless devices connected to the WHL 12 can operate in conjunction with one wireline device or with a group of wireline devices, e.g., that may be installed in an office or a house. When disconnected from the WHL 12, the wireless device 14, using standard procedures of, e.g., Cellular or PCS Networks, authenticates itself to operate as a stand-alone wireless device.

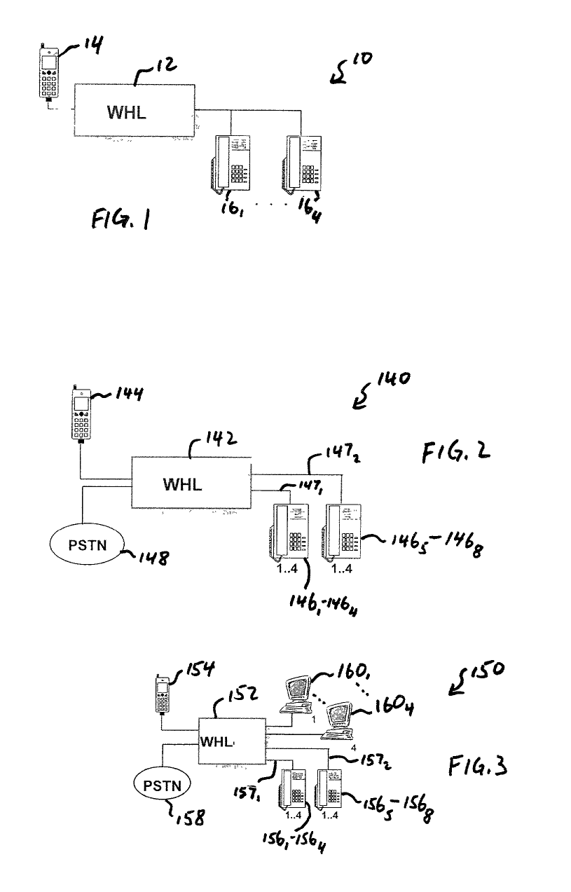

WHL systems can be implemented in different versions using the same or similar technology of a basic hardware and software architecture. Differences between versions may include capacity (quantity of devices and lines), and features (e.g., method of interconnection, support for data terminals, etc.). The technology is scaleable to various numbers of wired lines, wireless devices, extensions, and type of terminals (voice or data). For example, communications systems 20, 30, 140, and 150 shown in FIGS. 2-5, respectively, provide different capacities and features using WHLs 142, 152, 22, and 32, respectively.

Referring to FIG. 1, the WHL 12 provides for connection to the mobile phone 14, and to an extension with the phones 16. The WHL 12 has the mobile phone 14 as an access medium for the standard analog phones 16 connected in parallel as a single extension to the wireless network acting as the wireless trunk line connection. The phone 14 is connected to the WHL 12 through a cable that can, among other things, convey power to recharge a battery of the phone 14. The phones 16 are installed through an internal network, e.g., in a home or office.

Referring to FIG. 2, the WHL 142 provides for connections to a mobile phone 144, up to eight standard telephones 146₁-146₄, 146₅-146₈, and to a Public-Switched Telephone Network (PSTN) 148. The phones, 146₁-146₄, 146₅-146₈, are connected in parallel in groups of four each to two extensions 147₁, 147₂, respectively. The mobile phone 144 is physically connected to the WHL 142 in a similar manner as the phone 14 is connected to the WHL 12. The standard phones 146 can receive and make calls, including external calls such as local and long distance calls and calls to the Internet. A user of a standard phone 146 can choose whether to make an external call using the PSTN trunk line or a wireless network through the mobile phone 144. Caller ID of the mobile phone 144 is provided to the standard phones 146 via audible messages indicating the caller's ID. The incoming trunk lines (wireless or wireline) from the phone 144 and the PSTN 148 can be accessed in a sequential manner to provide a hunting functionality.

Referring to FIG. 3, the WHL 152 provides for connections to a mobile phone 154, up to eight standard telephones 156₁-156₄, 156₅-156₈, to a PSTN 158, and to four data terminals (here computers) 160₁-160₄. The phones, 156₁-156₄, 156₅-156₈, are connected in parallel in groups of four each to two extensions 157₁, 157₂, respectively. The mobile phones 154 is physically connected to the WHL 152 in a similar manner as the phone 14 is connected to the WHL 12. The standard phones 156 can receive and make calls, including external calls such as local and long distance calls and calls to the Internet. A user of a standard phone 156 can choose whether to make an external call using the PSTN trunk line or a wireless network through a mobile phone 154. Caller ID of the mobile phone 154 is provided to the standard phones 156 via audible messages indicating the caller's ID. The incoming trunk lines (wireless or wireline) from the phone 154 and the PSTN 158 can be accessed in a sequential manner to provide a hunting functionality.

The WHL 152 includes two different sections, a Voice section and a Data section. The Voice Section of the WHL 152 implements voice features of the WHL 152. The Data Section provides data connectivity for the WHL 152 between an Ethernet device and a data-ready wireless telephone. Data connectivity can be provided through wired or wireless connection. For wired connections, the WHL 152 acts similar to a 5-port 10/100 BaseT Ethernet switch. For wireless connections, the WHL 152 provides a wireless interface that supports IEEE 802.11 and Bluetooth standards.

The Data Section of the WHL 152 includes a data section controller, an Ethernet switch, a quad Ethernet interface, a wireless LAN (local area network) controller, an 802.11 interface, and a Bluetooth interface. The data section controller implements logic and protocols to exchange data between the wireless device and the Ethernet devices. This controller also exchanges control information with a voice-section microcontroller to negotiate voice and data connections. The Ethernet switch manages the data flow between 5 ports (one wireless device and 4 external Ethernet devices). The quad Ethernet interface is the physical connection and the electronic circuit connecting the Ethernet devices. The wireless LAN controller adapts between data from the data section controller and wireless network interfaces. The wireless LAN controller also implements high-level software for both wireless network standards. The 802.11 interface provides electronic circuitry and firmware to implement the 802.11 wireless network standard. The Bluetooth interface provides electronic circuitry and firmware to implement the Bluetooth wireless network standard.

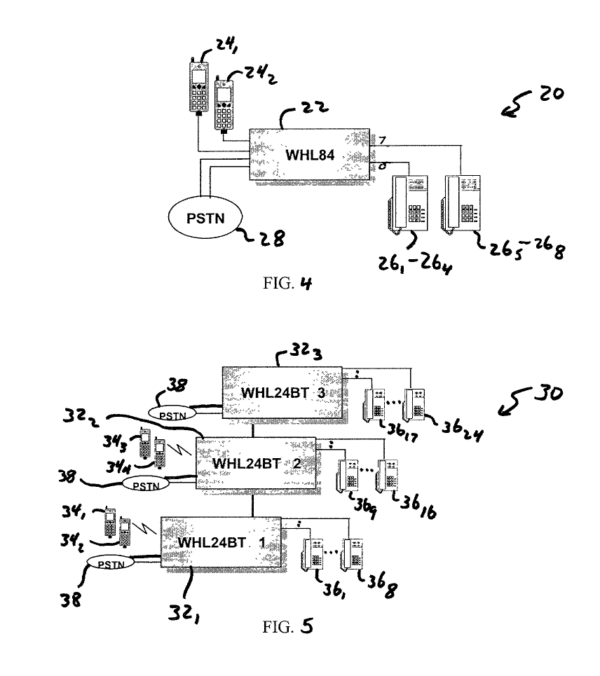

Referring to FIG. 4, the WHL 22 provides for connections of up to four mobile phones (wireless trunk lines) or analog trunk lines in any combination (here with connections to two wireless trunk lines to two mobile phones 24₁, 24₂, and two analog trunk connections to a PSTN 28), and up to 8 extensions with up to four standard phones 26 each, here with two extensions of four phones 26₁-26₄, 26₅-26₈, respectively. The mobile phones 24 are physically connected to the WHL 22 in a similar manner as the phone 14 is connected to the WHL 12. The standard phones 26 can receive and make calls, including external calls such as local and long distance calls and calls to the Internet. A user of a standard phone 26 can choose whether to make an external call using the PSTN 28 or a wireless network through a mobile phone 24. Caller ID of the mobile phones 24 is provided to the standard phones 26 via audible messages indicating the caller's ID. The incoming trunk lines (wireless or wireline) from the phones 24 and the PSTN 28 can be accessed in a sequential manner to provide a hunting functionality.

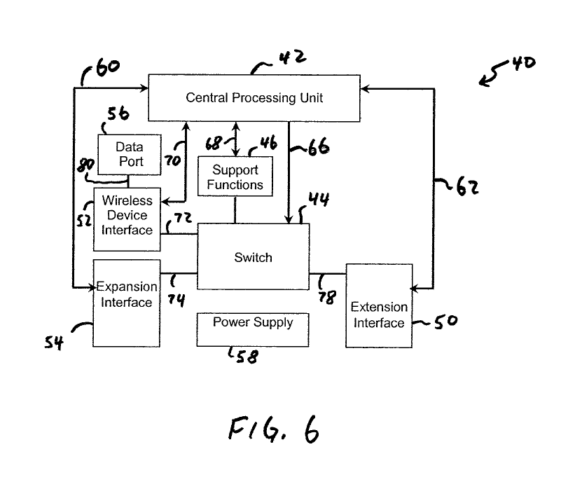

Referring to FIG. 5, each WHL 32 provides for connections of up to two analog trunk connections to a PSTN 38, up to 8 extensions of phones 36, and up to two mobile phones 34. The WHLs 32 can connect to up to 12 wireless or wireline connections in any combination. One WHL, e.g., 32₁, can be a master while the other WHLs 32₂, 32₃ serve as slaves, with the master transmitting control signals to the slaves and receiving responses from the slaves if appropriate. The mobile phones 34 are connected to the WHLs 32 using wireless functions according to short-range wireless technology, here according to the Bluetooth® protocol. The mobile phones 34 can be Bluetooth® masters with interfaces in the WHLs 32 serving as corresponding Bluetooth® slaves. The standard phones 36 can receive and make calls, including external calls such as to the Internet. A user of a standard phone 36 can choose whether to make an external call using the PSTN 38 or a wireless network through a mobile phone 34. Caller ID of incoming calls to the mobile phones 34 is provided to the standard phones 36 via audible messages indicating the caller's ID. The incoming trunk lines (wireless or wireline) from the phones 34 and the PSTN 38 can be accessed in a sequential manner to provide a hunting functionality.

The different WHL models 12, 22, 32, 142, 152 preferably use the same hardware architecture as described below. Depending on the model, certain hardware/software blocks are used/not used and/or installed, providing the described configurations by varying (e.g., upgrading or expanding) the use of certain circuitry.

Table 1 shows the basic configurations of systems 10, 140, 150, 20, 30 shown in FIGS. 1-5.

TABLE 1

| WHL | Extension | Trunk | Wireless | Scaleable |
|---|---|---|---|---|
| System # | Interfaces | Interfaces | Interfaces | Capability |
| 12 | 1 | 1 | 1 | Yes |
| 22 | Up to 8, each | Up to 2 | Up to 2 | Yes |
| | supporting up | | | |
| | to 4 standard | | | |
| | telephones | | | |
| 32 | Up to 8, each | Up to 2 | Up to 2 | Yes |
| | supporting up | | | |
| | to 4 standard | | | |
| | telephones | | | |
| 142 | Up to 8, each | 1 | 1 | Yes |
| | supporting up | | | |
| | to 4 standard | | | |
| | telephones | | | |
| 152 | Up to 8, each | 1 | 1 | Yes |
| | supporting up | | | |
| | to 4 standard | | | |
| | telephones | | | |

Each of the WHL systems 12, 22, 32 preferably use similar software architecture as described below. Depending on the model, some software blocks are enabled or disabled, used or not used, and some functionalities of a software block are enabled or disabled to configure the required product.

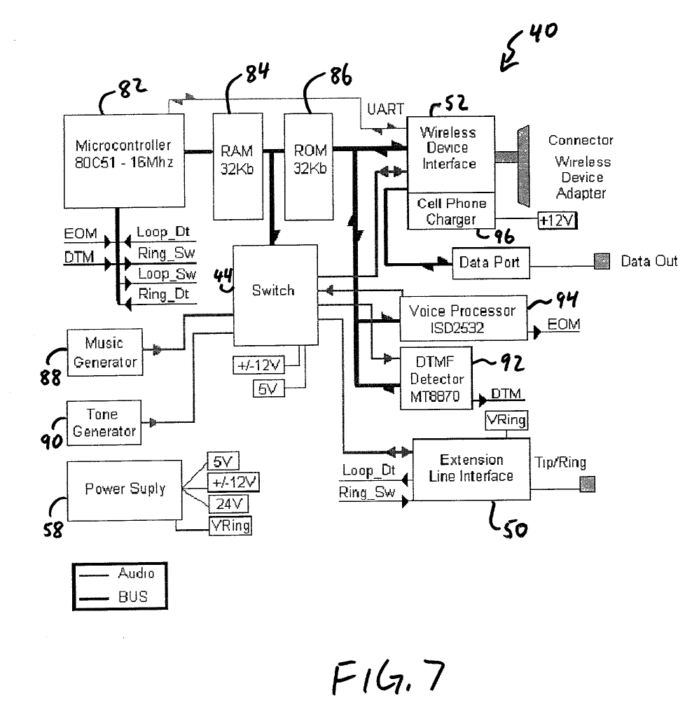

Referring to FIGS. 6-7, a hardware architecture 40 of the WHL 12 shown in FIG. 1 includes a central processing unit (CPU) 42, a switch 44, a support functions module 46, an analog and digital extension interface 50, a wireless device interface 52, an expansion interface 54, a data port 56, and a power supply 58. Voice communications 10 among the functional blocks are indicated in FIG. 6 by arrows 60, 62, 66, 68, 70, and control signals between functional blocks are indicated in FIG. 6 by lines 72, 74, 78, 80. Audio and bus connections are shown according to the legend in FIG. 7. The switch 44 implements an analog or digital matrix to provide switching capabilities between different interfaces. The switch 44 is a cross-point switch that connects audio signaling between two or more modules under command of a microcontroller 82. The switch 44, e.g., model M8816 made by Mitel Semiconductor of San Diego, Calif., receives a ±12V signal and a 5V signal from the power supply 58. The expansion interface 50 provides voice, data and control links between modules to help make the WHL 12 scaleable.

The CPU module 42 includes the microprocessor 82 and associated memories such as Random-Access Memory (RAM) and/or Programmable Read-Only Memory (PROM). The memories 84, 86 as shown can each store 32 Kb of data, including appropriate processor-executable instructions. Stored software in the ROM 86 controls other software modules, producing signaling that commands the operation of the hardware. Stored software may be written in a variety of programming languages such a C and assembler. The microprocessor 82 is an 8-bit microcontroller, e.g., model AT89C52 made by Atmel Corporation of San Jose, Calif., with a 16 MHz clock. The CPU module 42 controls all WHL operations, running WHL software and managing other functional blocks.

The support functions module 46 comprises circuits that implement special functionalities. These functionalities include producing a music signal, using a music generator 88, e.g., model UM66T, made by UMC Corporation of Sunnyvale, Calif. for music or audio on hold, tone generation, using a tone generator 90, to provide signaling tones (e.g., off hook), DTMF tone detection to detect digits from extension telephone sets, and voice processing to play pre-recorded voice messages. DTMF tone detection is performed by a DTMF (dual-tone multi-frequency) detector 92 model MT8870 made by Mitel Corporation of San Diego, Calif., that outputs a DTMF signal that is input to the microcontroller 82. Voice processing is accomplished with a voice processor 94 model ISD2532 made by Windbond Electronics Corporation of San Jose, Calif., that outputs an EOM (end of message) signal that is input to the microcontroller 82.

The analog trunk/telephone line interface 48 provides electronic connection to analog trunk/telephone lines. This interface 48 supplies hardware resources for detecting a terminating/incoming call and for originating a call using a wireline connection. The interface 48 can connect to multiple trnk/telephone lines to the PSTN 28 or 38, as shown in FIGS. 4 and 5, respectively. The interface 48 can bi-directionally convey audio information with the switch 44, and receive a Loop_Sw signal (loop-switch signal) and a Ring_Dt signal (ring detection signal) from the microcontroller 82. The Loop_Sw signal indicates that a phone has been taken off hook and that an appropriate circuit should be closed to enable a conversation. The interface 48 connects to a line out and a line in for sending and receiving data to and from, respectively, the PSTN 28 or 38.

The extension interface 50 provides electronic connection to analog or digital telephone sets. This interface 50 has hardware resources to power-on the telephone sets, send ring tones, detect loop status and digits, and to originate calls from or terminate calls at a regular analog/digital telephone set. The interface 50 can provide connection to multiple wireline phones connected in parallel as shown in FIG. 1, and/or to multiple extensions as shown in FIGS. 4-5. The interface 50, can bi-directionally convey audio information with the switch 44, and receive a Loop_Sw signal and a Ring_Dt signal from the microcontroller 82. The extension interface outputs a tip/ring signal. The extension interface 50 receives a ring voltage signal VRing from the power supply 58 for providing the ring output to cause a telephone to ring.

The wireless device interface 52 provides electronic connections to wireless devices. The interface 52 has hardware resources to exchange data between wireless devices and WHL software control. The wireless device interface 52 is configured to accommodate different wireless devices. Connection between the interface 52 and the other blocks is preferably designed to accommodate any wireless device model available in the market by providing translation and adaptation functionalities into the wireless interface 52, regardless of the wireless device model. The interface 52 can provide connections, wired or wireless, to one wireless device 14 as shown in FIG. 1 or to multiple wireless devices 24, 34 as shown in FIGS. 4 and 5, respectively. The interface 52 includes a mobile-phone charger 96, e.g., model M34063, made by SGS Thomson Microelectronics Inc. of Nepean, Ontario, that receives a +12V signal from the power supply 58. The interface communicates bi-directionally with the microcontroller 82 with UART (universal asynchronous receiver-transmitter) signals.

The data port 56 is configured to receive data from the wireless device 14. The data port 56 can be connected to a hub or data switch to distribute bandwidth, e.g., within an office or a house using the wireless device network for this connection.

The power supply 58 provides power signals, of different voltage levels as appropriate, for other circuits. Output voltage signals are 5V, ±12V, 24V, and VRing. The signals can be used, e.g., to ring extensions and to charge a battery when the wireless device 14 is physically connected to WHL 12. The power supply 58 can be a combination of discrete components such as diodes, resistors, capacitors, transistors, and operational amplifiers, such as model LM2576 made by National Semiconductor Corporation of Santa Clara, Calif.

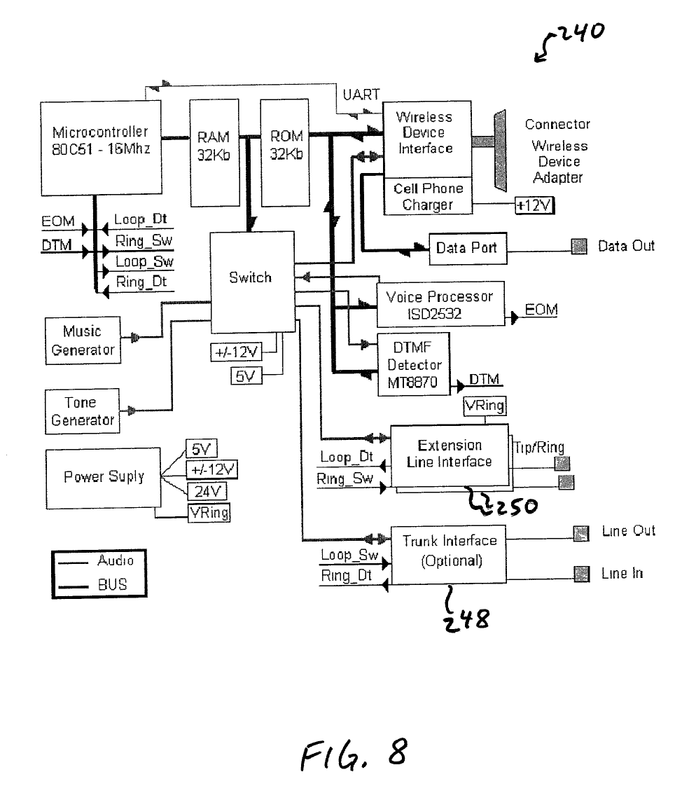

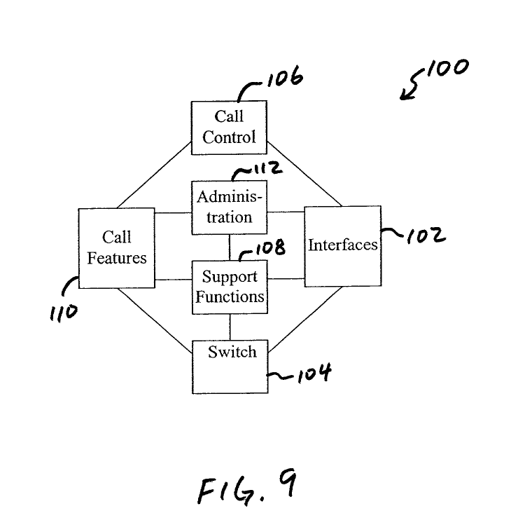

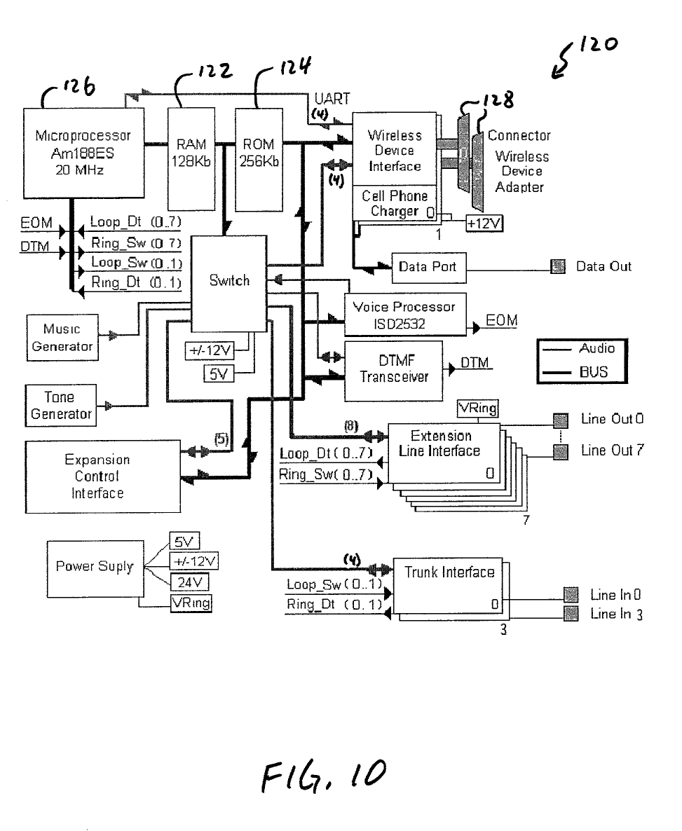

Referring to FIG. 8, a hardware architecture 240, for the WHL 142 shown in FIG. 2, is similar to the architecture 40 shown in FIG. 7. The architecture 240, however, includes multiple extension line interfaces 250 for the multiple extensions 147 connected to the WHL 142. The architecture 240 also includes an optional trunk line interface 248 for connection to the PSTN 148 (FIG. 1).

Referring to FIG. 9, a WHL software architecture 100 includes functional blocks as shown. These blocks/modules include an interfaces module 102, a switch module 104, a call control module 106, a support functions module 108, a call features module 110, and an administration module 112.

The interfaces module 102 controls hardware interfaces that connect the WHL 12 with external entities. The interfaces module 102 detects device status, provides data and information to other WHL software modules, and enables signaling to external devices. Included with the interfaces module 102 are extension, trunk, wireless, and expansion submodules.

The extension submodule handles signaling, such as ringing, to/from telephone sets. This submodule also detects and handles signals to other WHL software modules such as: on-hook status, off-hook status, flash, and first DTMF digit.

The trunk submodule handles signaling to/from wireline links by processing inputs from other WHL software modules. This processing includes a procedure to initiate a calling process. The trunk submodule provides outputs to other WHL software modules to perform ring detection.

The wireless submodule handles signaling to/from wireless devices. The wireless submodule treats inputs from other WHL software modules to perform tasks such as sending digits, disconnecting the wireless device, authentication, disconnecting authentication, dialing numbers, and performing end of call. This submodule generates outputs to other software modules providing information about the execution of functions. This information includes wireless device is connected, wireless device is disconnected, release bottom is pressed, authentication is done, and caller ID number.

The expansion submodule handles signaling to/from other WHL expansion modules. The expansion submodule helps the system be scaleable.

The cross-point switch module 104 is responsible for managing the physical connection (cross-point) between two entities. Different types of entities include extension lines, trunk lines, wireless device audio links, DTMF detector, voice processor, tone generator, music generator, internal conversation links, and external conversation links (other WHL modules). Input functions provided by the switch module 104 to those entities are connect and disconnect. Output functions to other software modules include switching function is completed, no internal conversation link available, and no external conversation link available, where internal refers to within the WHL and the standard telephones and extensions, and external refers to the PSTN and the wireless/mobile phones.

The call control module 106 controls each call as a high-level software supervisor that controls basic functions including call establishment, conversation in progress, and call disconnection. The call control module 106 is concerned more with high-level functions rather than call details, with details and specific functionalities for calls handled by the call features software block 110 according to the type and characteristics of particular calls. The module 106 receives incoming call, on hook, and dial digit (indicative of a particular entry, e.g., on a phone keypad) inputs from other software modules and sends dial number (indicative of a destination phone number), extension status, and incoming call outputs to other software modules.

The support functions module 108 provides specific functionalities to other software modules for DTMF detection, voice processing, tone generation, and music generation. Each of these functionality blocks are provided for in submodules of the support functions module 108.

A DTMF detector submodule detects digits in DTMF format sent from telephone sets. By detecting digits, the DTMF submodule interprets the services from certain software modules and sends a response for those service requests. The DTMF submodule receives inputs from other modules, the inputs including connect DTMF detector and disconnect DTMF detector. The DTMF submodule sends, to other modules, outputs including digit received, DTMF detector connected, DTMF detector busy, and DTMF detector idle.

A voice processing submodule plays voice prompts according to requests from other modules. Inputs from other software modules include an indication to play prompt X, where X is a number associated with a prompt. The voice processing module can send outputs including service requested executed, and voice processor busy to other software modules.

A tones generator block produces tones in accordance with received requests. This block can accept numerous requests from different modules, and produce multiple tones simultaneously. Inputs receivable from other modules include start tone and stop tone. Outputs to other software modules include service requested executed.

A music generator submodule generates music and an audio signal when the telephone is “on hold”. Inputs from other software modules include start music/audio and stop music/audio. Outputs to other software modules include service requested executed.

The call features module 110 provides specific functionality for types or features of calls. To accommodate these types and features, the module 110 includes: internal call; incoming call; outgoing call; inquiry, transfer and conference; hold; call back; and call waiting submodules.

The internal call submodule handles calls between two extensions from the same WHL 22, 32, 142, 152. This submodule detects the initiation of a call in response to the call control module 106 recognizing that it is an internal call by analyzing the first digit dialed. The internal call submodule continues to handle this call until one extension hangs up or requests another call feature.

The incoming call submodule handles calls from a trunk line. This submodule detects the call, through a service request from the call control module 106, in response to the trunk interface block detecting ringing. The incoming call submodule continues to handle the call until the called extension hangs up or requests another call feature.

The outgoing call submodule handles calls to a trunk line. This submodule detects the origination status of a call in response to the call control software module 106 recognizing that the call is an outgoing call by analyzing the first digit dialed by a user. The outgoing call block continues to handle the call until the calling extension hangs up or requests another call feature, or the called party hangs up.

The inquiry, transfer and conference (ITC) submodule takes care of a call in response to the call control 106 recognizing that an extension, as a party, requests an inquiry to another extension or external line. The ITC block continues to handle this particular call as the inquiry changes to a transfer or a conference. If the call is to be transferred, the control of the call goes to the internal call block or the incoming call block depending on which types of parties are in the call (two extensions or one extension and one external line). If the call is to become a conference call, the ITC submodule continues to handle this particular call until one of the parties leaves the conference. In response to a party leaving, control of the call goes to the internal call block or the incoming call block depending on who stays on the call.

The hold submodule handles a call in response to the call control 106 recognizing that an extension requests service to hold the call. The hold software block continues to handle the call until the extension releases the hold. In response to the hold being released, the control of the call returns to the internal call block (two extensions) or the incoming call block (one extension and one external line).

The call-back submodule implements a call back feature. If a call-back (to an extension or an external line) is requested, this block tracks both the parties to determine when both are idle. When this condition occurs, the call back block rings the extension that armed the call back function. In response to that extension answering the call, the call back software block proceeds with connecting both parties and transferring control of the call to the internal call or the incoming call block (if the other party is an external line). If during this process the other party goes to a busy state, the call back is set to idle, restarting the process of tracking both parties to determine when they are free.

The call waiting block takes care of the call, by request of the call control block 106, in response to when the call control block 106 detects that the called extension programmed a call waiting indication. If the called extension is in conversation with another extension or a trunk line, the call waiting block transfers control of the call to the ITC block. If the called extension is connected to a wireless device, a set of instructions is sent to the wireless device to accept or reject the waiting call, according to the user's option. In this case, the call is handled by the wireless network system.

The administration module 112 handles data programming. The module 112 takes care of the call in response to the call control block 106 detecting that the user intends to program data or wants set-up features. The administration block 112 implements commands and communication with users in order to set up programmable data. Preferably only this block can modify programmed data.

The WHL is designed to be simple to use and to administrate. To provide WHL functionalities, a small set of parameters is programmed. To program, a user takes the phone, connected to the WHL, off hook and presses 1. This instructs the call control software block 106 to indicate to the administration software block 112 that the module 106 is ready to accept programming commands. Those commands are a sequence of digits with a format of cc data₁ [data₂] . . . [dataₙ] where cc is a two-digit command code, and data₁, data₂, dataₙ are data fields with different numbers of digits and depend on the specific command. The notation [data] indicates that it is optional, such that each command could have one or more data fields. Each time a command is completed, the WHL plays a voice message indicating that the command was accepted or not. If the command was accepted, new data are validated and stored. If the command was rejected, the command may be retried.

The WHL 12 and/or 22 and/or 32 can provide a variety of call features. These features include flexible or fixed extension numbering, voice instructions, internal and external calling, incoming and outgoing calling, distinct external line selection, speed dialing, hotline, groups of extensions, distinct ringing, caller ID, hold, inquiry, transfer and conference, call waiting, and call back.

The WHL can be implemented using a flexible numbering or a fixed numbering scheme. With fixed numbering, each extension is identified by the physical terminal to which it is connected to the WHL. With flexible numbering, the WHL allows each extension number to be programmed regardless of its physical interconnection position at the WHL.

With the voice instruction feature, the WHL gives users instructions on how to proceed in some particular situations using pre-recorded messages. Voice messages replace some instructions traditionally given by tones. Exemplary messages are: “Number not available,” “Press 0 to answer or hang up,” “There is a call from,” “Programming is completed,” “Programming error,” “The call was not completed. Please hand up and call again,” and “Your call cannot be completed at this moment. Please call later.”

The WHL can also handle internal and external calls, with external calls being either incoming or outgoing. Internal calls may be completed between two extensions. External calls made be completed between an internal extension to one external wire or wireless line. For incoming calls from an external line to an extension, it may be defined which extensions receive calls from each external line. For outgoing calls from an extension to an external line, there is preferably no calling number discrimination. Thus, preferably any dialed number from an extension goes directly to the external line. There is preferably no different extension category for external calls.

The distinct external line selection feature allows a selection of which type of line (wired or wireless) to use to make an external call. For example, the first digit dialed will select the type of line. The digits may be: 8 select a wireless line, 9-select a wired line, 0-make an external call without specifying an external line type. As opposed to such manual selection, the selection of wired or wireless network can be made automatically. To make this choice, a variety of factors can be accounted for including: whether the call is local or long distance; if long distance, to where specifically is the call directed; the rate plans of the wireless and wireline networks for the system/user, this can include amounts of free minutes, time of day, day of week, typical amounts of call minutes per month (e.g., a network may be preferred even if the current rate is higher than the other network's current rate if there is a price break for more minutes such that the average for the month will make using the selected network for the current call cheaper than using the other network's current rate). The system can evaluate one or more factors to determine which network to choose to reduce cost, be it for that particular call only, or on a larger scale such as a monthly cost.

The speed dialing feature provides a shortcut for dialing numbers, e.g., that are frequently called. As an example, up to 10 pre-programmed external numbers for use by any extension. Speed dialing features of the wireless device 14 can be provided to the wireline extension phones 16, 18.

The hotline feature provides for making an external call to a pre-programmed number without dialing. If no number is dialed during the first 5 seconds (after off hook status is detected), an automatic external call is made.

The WHL can link one or more extensions as a group to each external line (wired or wireless). In this case, when a call arrives on a particular external line, only one of the linked extensions will ring. If there is no extension linked with an external line, when a call arrives on that line, only the bell of a predetermined extension, e.g., 36, for WHL 32, will ring.

Distinct rings may be provided to audibly differentiate incoming calls. There are two different ringing models to distinguish calls from a wired or from a wireless line, or from different wireless connections or wirelines. This feature is programmable and can be disabled or enabled by the user.

The WHL can provide caller identification, e.g., if an extension answers an external call. The identification is made by voice announcement and may also be indicated on a display. This feature should be deactivated for each external line that has no caller identification functionality. For example, operation of this feature could be as follows. If an external line has caller ID and the WHL caller ID feature is active, in response to an extension answering an external call from that line, the WHL will announce: “There is a call from ‘caller ID (digit by digit)’. Press 0 to answer the call, or hang up.” If the user presses 0, the call is passed to the extension. If the user hangs up, the WHL sends an <end> command to a wireless line or releases a trunk line, as appropriate. If the external line has no caller ID and the WHL caller ID feature remains active for this particular line, the WHL announce: “There is a call from a number not available, press 0 to answer the call, or hang up.” If the external line has caller ID, but the WHL caller ID feature is not active for this particular line, the WHL will not announce anything and the call is put through after the extension answers the call.

The WHL provides several features that are available after a call has been established. These features include hold, inquiry, transfer and conference, and call waiting. These features are available when an extension is already in a conversation with an external line or another extension. The user can access each of the features described below, e.g., by pressing the flash key and then 1 for hold, 4 for inquiry, and 7 for call waiting. In response to the flash key being pressed, the WHL can instruct the user how to proceed by playing a short pre-recorded message such as “Press 1 for hold, 4 for inquiry, or 7 for call waiting.”

During a conversation, an extension can put the call on hold and hang up. The held party stays on the call listening music (the WHL provides digital music). If the holding extension does not release the hold after 30 seconds, the WHL rings the holding extension. If the holding extension does not answer, the call is released.

With the inquiry, transfer and conference (ITC) feature, during a conversation, an extension can put the other party on hold and start a new call to another extension or to an external line. During conversation with the third party, the holding extension can: switch between the parties, putting one or the other on hold (inquiry); transfer the call, putting the other two parties in conversation, and leaving the call (transfer), and/or put all three parties in the same conversation (conference).

With the call waiting feature, during conversation, an extension may receive a tone or other indication that there is another call from another extension or an external line. The extension can answer the second call, putting the first on hold. The call can continue according to the ITC feature described above. If the incoming call is an external call, the caller ID function may implemented as described above.

The call back feature provides for calling an extension or external line back if an extension finds another extension or an external line busy. Call back is activated by pressing the flash key. When both the extension and the other party (marked for call back) are idle, the WHL rings the extension that requested the call back service and waits to receive the information that the extension answered the call. The WHL informs the user, by playing a pre-recorded message, that it is performing call back and rings the other extension or selects the external line. If the other party becomes busy before the extension answers the call back, the call back process is restarted after both parties are simultaneously idle again.

Table 2 shows which features described above are available on the WHLs 12, 142, 152, 22, 32 shown in FIGS. 1-5, respectively.

TABLE 2

| WHL call feature | WHL 12 | WHL 22 | WHL 32 |
|---|---|---|---|
| Predefined Extension Numbering | No | Yes | Yes |
| Internal call | No | Yes | Yes |
| Voice Instructions | Yes | Yes | Yes |
| External call | Yes | Yes | Yes |
| Distinct line selection | Yes | Yes | Yes |
| Speed dialing | Yes (1) | Yes | Yes |
| Hotline | Yes | Yes | Yes |
| Groups of extensions | No | Yes | Yes |
| Distinct ring | Yes | Yes | Yes |
| Caller ID | Yes | Yes | Yes |
| Features during a call | Yes (2) | Yes | Yes |
| Call back | Yes (2) | Yes | Yes |

(1) Only for wireless external line
(2) Only for external lines

The WHL 12 provides a variety of characteristics for telecommunications. These characteristics are related to the mobile phone 14, the wireline phones 16, 18, control, power, and user facilities and services.

With respect to the mobile phone 14, characteristics of the WHL 12 include commands received by and sent from the WHL 12, and a physical interface with the phone 14. Commands received by the WHL 12 from the phone 14 include an incoming call arrival announcement, caller ID (providing indicia of a calling party), call waiting announcement (indicating another arriving call), and message arrival announcement. The WHL 12 can issue commands to the phone 14, including call answering (to answer an incoming call), a called party number (e.g., as entered at a wireline phone 16), audio volume adjustment, access to mobile service resources (instructing the phone 14 to use, e.g., speed dial of the mobile phone 14), keypad blockage to turn off the keypad of the mobile phone 14, and disabling mobile phone ringing. The physical interface between the WHL 12 and the phone 14 is configured to convey audio and control signals bi-directionally, and to convey energy for battery recharging. This interface is preferably adaptable/applicable to different types of phones 14, e.g., such that different phones 14 may be connected to by using different connecting cables without further accommodations.

The WHL 12 is configured to work with the wireline phones 16. Preferably, these phones 16 are standard, “off-the-shelf” wireline-network analog phones, such as hard-wired, fixed, phones or cordless phones. The WHL 12 is configured to simultaneously ring up to four such phones connected in parallel, and to supply power to two phones in off-hook status. Appropriate power protection is provided for the event that more than two phones go off hook. The WHL 12 is configured to detect hook status (on or off) and flash signal (e.g., for call waiting). An audio circuit establishes an audio connection between called and calling parties for both internal and external calls.

The WHL 12 is also configured to control aspects of operation of the system 10. The WHL 12 can detect DTMF tones, control the interface with the phones 16, 18 including producing different rings and detecting hook status and flash signals, and produce tones such as 425 Hz dial tones. The WHL 12 can also control the interface with the mobile phone 14. Audible caller ID messages can be provided to the phones 16, 18 under control of the WHL 12. The WHL 12 can switch audio signals from the mobile phone 14 to the phones 16.

The power supply of the WHL is configured to provide sufficient power to perform WHL operations. The power supply supplies power to WHL circuitry, supplies a ring signal with the capacity to ring up to four phones simultaneously, and supplies power to recharge the batter of the mobile phone 14.

The WHL 12 provides services to the user similar to those offered to the user of the mobile phone 14. A user can answer a call received by the mobile phone 14 by picking up or activating any of the phones 14, 16, 18. The WHL 12 performs operations to answer the call (to the mobile network site) and connects the mobile phone 14 to the phone that has been picked up/activated. To make a call, a user can pick up/activate a phone 14, 16, 18, wait for a dial tone, and dial a desired phone number in ordinary manner. If the mobile phone has caller ID, indicia of a caller can be sent to a wireline phone 16, 18 as an audio message. For example, a wireline phone user can answer a call, receive an audio message announcing an identity of (or associated with) the caller or calling device, and be connected to the call by pressing a flash key. If the mobile phone 14 offers call waiting, a user can be connected to a waiting call by pressing a flash key. The WHL 12 can send, via the mobile phone 14, a sequence of information to instruct a Mobile Switching Center (MSC) to put the first call on hold and connect the second call.

With any WHL, wireless devices are authenticated, e.g., each time that a wireless device transitions from unconnected to the WHL to connected to the WHL. Each WHL has an identification number (WHL ID) similar to the Mobile Identification Number (MIN) of a wireless device. This WHL ID is registered at a wireless service provider as a special billing number, with a corresponding billing structure. Also, the WHL ID is stored in a Home Locator Register (HLR) database. A DMH_BillingDigits parameter (that specifies the telephony billing number for calls with special billing arrangements to identify the party to be billed), that is in a profile of the WHL, is programmed with the WHLID(s) of the wireless device(s) that is(are) associated with the WHL. Also, a WHL profile GeographicAuthorization parameter is set to “authorized for the cell(region) only,” which corresponds to the best cell(region) that covers the area where the WHL will be installed. Setting the GeographicAuthorization parameter to “authorized for the cell(region) only,” will help avoid using the WHL in places other than the one that is authorized by the parameter.

With the WML profile registered with a wireless service provider network, special billing rules for the wireless device(s) that is(are) connected to the WHL can be associated with the registered profile. The wireless service provider can offer differentiated billing rates for any wireless device connected to a WHL. These rates may be competitive with rates for the wireline service available to the extensions connected to the WHL. Calls made through the WHL will be billed in accordance with the DMH_BillingDigits parameter. The MSC is informed that a mobile phone is connected to the WHL to identify the connection status of the telephone, helping to provide differentiated rates for the mobile phone while connected to the WHL versus while disconnected from the WHL. Preferably, the MSC is informed of a disconnection when, or very soon after, a mobile phone is disconnected from a WHL.

If two wireless devices use a WHL, the wireless service provider can program the wireless device profile (DMH_BillingDigits) with the same WHL ID of that particular WHL. The same programming process can be used for other wireless devices that may be connected to a particular WHL.

In response to a wireless device being connected to a WHL, a new authentication process is performed to update wireless functional entities (e.g., MSC, VLR (visitor location register) and HLR) databases. This new authentication helps the wireless network originate and terminate calls to that wireless devices using the WHL functionality. Information sent from the WHL to the MSC differs from information sent to the MSC from a mobile phone that is disconnected from the WHL, helping the MSC identify the connection status of the mobile phone.

Authentication processes differ depending upon whether the wireless device is physically or wirelessly connected to the WHL. For the WHL 12 and WHL 22, where the wireless devices are physically connected to the WHL, the WHL sends commands to the wireless device to turn the wireless device off, causing a de-registration of the wireless device from the wireless network. The WHL may send one or more instructions through the wireless device to cause an automatic de-registration of the wireless device from the wireless network. De-registration updates the user profile at the MSC, VLR and HLR. The WHL also sends commands to the wireless device to turn the wireless device on, or instructs it to perform a new registration using the WHL line identification number. This will instruct wireless functional entities to use the WHL functionality for calls made through that wireless device. For authentication of a Wireless Device connected to a WHL using the Bluetooth® protocol (or other wireless technology), the wireless device automatically starts a new authentication as part of the procedures to enter into the WHL piconet.

Wireless devices that are disconnected from the WHL are re-authenticated with the wireless network. The wireless device automatically starts a de-registration procedure in response to being disconnected from the WHL. In response to being powered on again and not being connected to the WHL, the wireless device authenticates normally with the wireless network. In this case, the wireless device uses the MIN of the device (not the WHL ID), enabling mobility and access to the services provided by the Wireless Service Carrier for a regular mobile wireless device.

WHLs can be operated without electricity. In case of power loss, preferably at least two operations occur. One, the mobile telephone will be kept on if connected to the WHL, for a period, e.g., of 12 hours, using the WHL battery to help avoid the occurrence of wrong authentications. Two, in the WHL 22 and WHL 32 (or WHL 12 with optional trunk interface), each wire line is connected to a telephone extension automatically.

For powering the WHL, preferably a readily-available external power source is used. Voltages levels that are not supplied by the power supply, and the ring voltage VRing are internally produced by the WHL. The WHL 12 and the WHL 22 models offer voltage to recharge the connected cellular phone battery.

Installation of the WHL is preferably simple, using common and familiar methods of connection. For example, modular-jack type connectors may be used, where the female connectors are mounted in the WHL. Also, the power source may preferably be installed by plugging into a wall outlet and via cable to the WHL. Further, a WHL enclosure box that allows wall-mounting installation may be used.

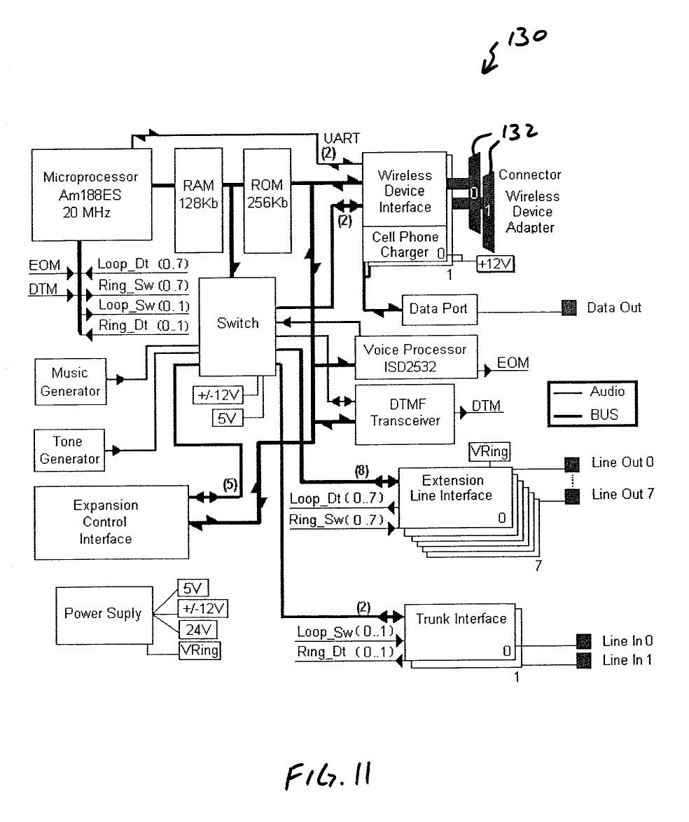

Referring to FIG. 10, a hardware architecture 120 of the WHL 22 shown in FIG. 4 is similar to the architecture 40 shown in FIG. 7 for the WHL 12 shown in FIG. 1. The WHL 22 has more interfaces, can be connected to other WHL modules, and uses a more powerful controller and more memory capacity then the WHL 12. The architecture 120 includes a 128-Kbyte RAM 122 and a 256-Kbyte ROM 124. The WHL 22 uses a 20 MHz microprocessor 126 model Am188ES made by Advanced Micro Devices of Sunnyvale, Calif. Extension line interfaces, trunk line interfaces and wireless device interfaces are similar, and possibly identical, to those used in the WHL 12. The number of circuits in the WHL 22, however, of each interface differs from the WHL 12. The WHL 22 provides for connection to up to 8 extensions, and thus the architecture 120 includes 8 extension line interface circuits and 8 corresponding Loop_Dt and Ring_Sw signals. The WHL 22 provides for connection to up to four wireless devices 24, and thus the architecture 120 includes four wireless device connectors 128, and four of the associated signals (e.g., UART signals). The WHL 22 provides for two connections to the PSTN 28 wireless devices 24₁, 24₂, and thus the architecture 120 includes four trunk interfaces and four corresponding Loop_Sw and Ring_Dt signals. Support functions are the same as, or similar to, those used by WHL 12. Software functionality is similar to that described with respect to FIG. 9.

The WHL 22 provides characteristics similar to those provided by the WHL 12 for telecommunications, although some differences do exist. With respect to the wireline phones 26, the WHL 22 is configured to ring (with power from the power supply) two telephones simultaneously, one extension with up to two telephones connected in parallel. The WAIL 22 is configured to provide power to one telephone in off-hook status. For interfacing with analog trunk lines, the WHL 22 provides ring detection, generation of pulse dialing, and audio circuitry (for establishing a connection between called and calling parties). More differences exist with respect to control.

The WHL 22 differs from the WHL 12 in control characteristics, with some being different and some additional characteristics. The WHL 22 controls interfaces with two mobile phones 24 as opposed to one mobile phone 14. The WHL 22 also controls two analog trunk interfaces to the PSTN 28. Control processing also includes voice processing for voice-activated commands in addition to audible caller ID announcement. The WHL 22 is further configured to provide analog switching control for the trunk lines, extensions and peripheral circuitry (e.g., tone generation, DTMF detection, and voice processing) to convey analog signals to appropriate destinations.

The WHL 22 provides user facilities and services that also differ from those provided by the WHL 12. Caller ID and call waiting available through the mobile phones 24 are provided similarly to as provided by the WHL 12. For Private Branch Exchange (PBX) operation, the WHL 22 provides fixed extension numbering; calls between extensions; incoming and outgoing calls; hold, inquiry, transfer and conference; defined extension groups associated with each trunk for incoming calls; different rings for different trunk lines; call back for extensions and trunk lines; call waiting announcement for extensions; and different key selection for use of wireline or wireless network. A voice interface may be used that instructs users and recognizes phrases and words of user answers to activate facilities that involve user interaction.

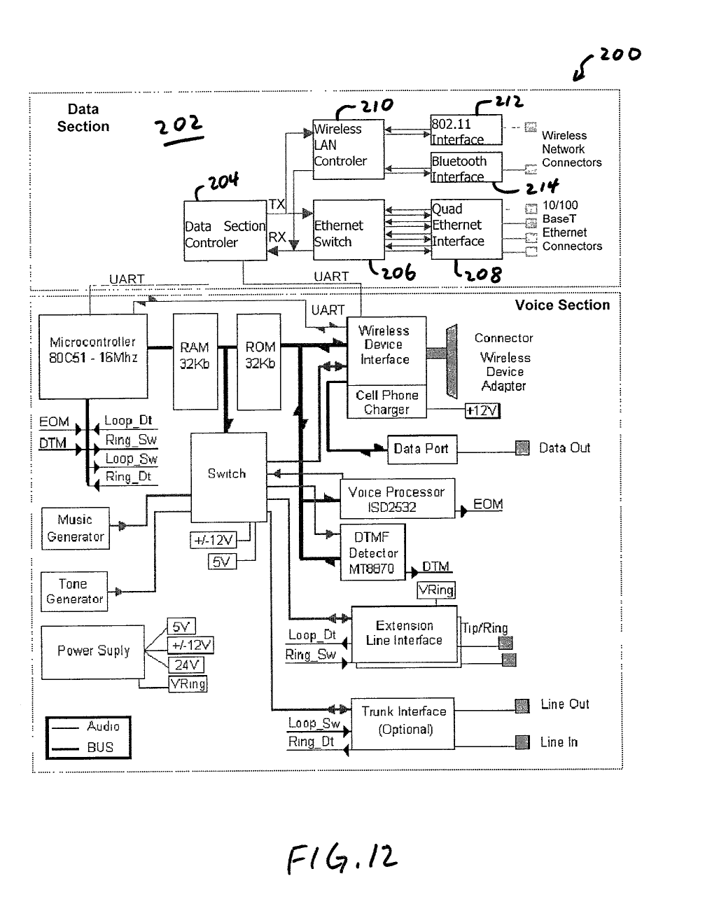

Referring to FIG. 11, a hardware architecture 130 of the WHL 32 shown in FIG. 5 is similar to the architecture 120 shown in FIG. 10 for the WHL 22 shown in FIG. 4. The WHL 32 wireless device connectors 132 that operate wirelessly, e.g., using a short-range wireless protocol, here the Bluetooth® protocol, to communicate with the wireless devices 34₁-34₄.

The WHL 32 provides characteristics similar to those provided by the WHL 22 for telecommunications, although some differences do exist. User facilities and services provided by the WHL 32 are similar to those provided by the WHL 22. With respect to the mobile phones 34, the WHL 32 is configured to communicate with the phones 36 using Bluetooth® specifications version 1.1. The power supply of the WHL 32 need not supply energy for recharging mobile-phone batteries. More differences exist with respect to control.

The WHL 32 differs from the WHL 22 in control characteristics, with some being different and some additional characteristics. The WHL 32 controls interfaces with two mobile phones 34 according to the Bluetooth® protocol. Voice and data communication are provided between WHL modules. The WHL 32 also controls its operation as a master WHL or a slave WHL.

Calls made to a wireline connected to the WHL 22 or 32 may be forwarded to the mobile telephones if these lines are busy or not available. There are at least three options for the execution of this call forwarding: operator agreements, automatic, and user activated.

With the operator agreements call-forwarding option, in response to the MSC receiving information that a mobile telephone 26, 36 is connected to a WHL 22, 32 (e.g., through an authentication process) the MSC communicates with a wireline Central Office (CO) that provides service to the user. The MSC transmits information for the call forwarding to occur. In response to the MSC receiving information that the mobile phone 26 36 is disconnected from the WHL 22, 32, the MSC communicates with the CO to deactivate the call forwarding.

With automatic call forwarding, in response to connection of the mobile telephone 26, 36 to the WHL 22, 32, the WHL 22, 32 uses the wireline(s) to send a code sequence that activates call forwarding to the connected mobile phone 26, 36. This process is repeated in response to disconnection of the mobile phone 26, 36 and termination of call forwarding. This process assumes that the wireline offers such functionality.

With user-activation call forwarding, the user initiates, e.g., by pressing a button, either process described above. In other words, either the WHL 22, 32 informs the MSC of the redirection or the WHL 22, 32 uses the wirelines to send these commands.

Referring to FIG. 12, a hardware architecture 200 of the WHL 152 shown in FIG. 3 is similar to the architecture 120 shown in FIG. 10. The architecture 200, however, includes a data section 202 that includes a data section controller 204, an Ethernet Switch 206, a quad Ethernet interface 208, a wireless LAN controller 210, an 802.11 interface 212, and a Bluetooth interface 214. The controller 204 can be, e.g., model CS89712 made by Cirrus Logic of Fremont, Calif. The switch 206 can be, e.g., a single-chip Tres KS8993 made by Kendin of Sunnyvale, Calif. The quad Ethernet interface 208 comprises discrete components.

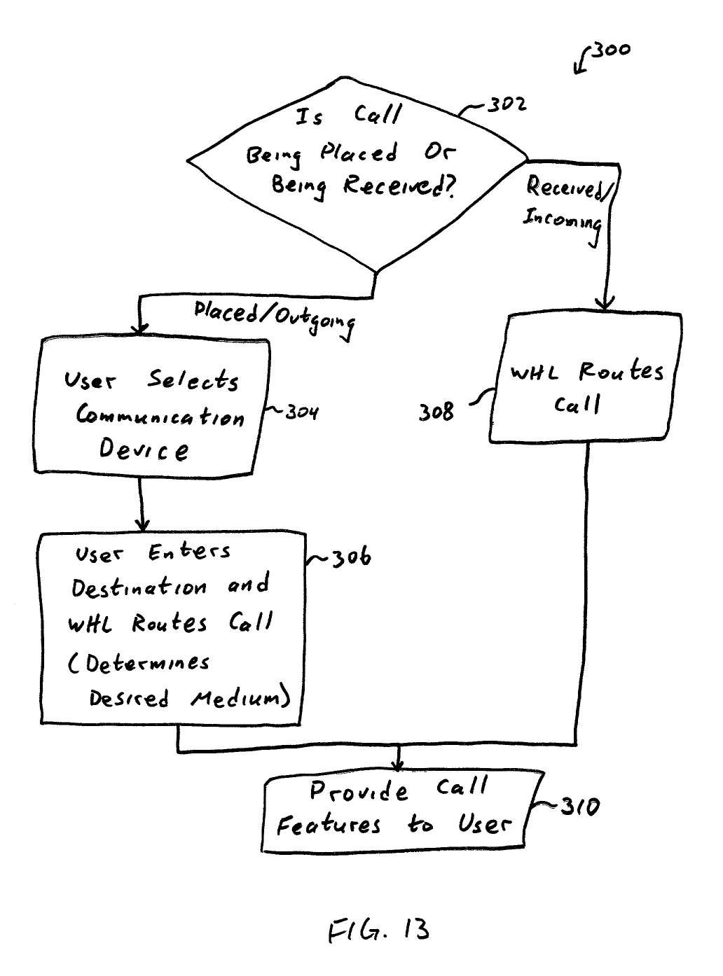

In operation, referring to FIG. 13, with further reference to FIGS. 1-5, a process 300 for placing and receiving calls (including phone calls or other communications such as from/to data terminals 160), using any of the systems 10, 20, 30, 140, and 150, includes the stages shown. The process 300, however, is exemplary only and not limiting. The process 300 can be altered, e.g., by having stages added, removed, or rearranged. At stage 302, the process begins with whether the call is to be placed or received, with the process 300 following different paths depending on whether the call is incoming or outgoing.

At stage 304, for outgoing calls, a user selects a communication device. This device may be a wireless phone, a landline phone, or a data terminal depending on the system used by the user. The user enters a destination device ID (e.g., a phone number) using the selected device.

At stage 306, the selected device communicates the destination device ID through the corresponding WHL to initiate the call. For calls between multiple extensions, the WHL routes the call internally. For other calls, the WHL determines how to route the call, if an option exists. For example, if the WHL has multiple telecommunication media connections, in addition to that used by the selected device, for completing calls (e.g., two or more PSTN connections or wireless phones in any combination), then the WHL determines which medium to use. The WHL can automatically do this, e.g., by factoring in various cost elements related to the various media and rate plans, etc., to determine, e.g., a least-cost medium, be it least-cost for the particular call or least-cost on average, or other. The WHL can also prompt the user to select which medium to use.

In determining the desired medium, the WHL may recognize that a wireless device is connected to, or otherwise associated at least temporarily with the WHL, and thus available for the call, and use a stored rate plan that is different than if the wireless device is not associated with the WHL. Also, or alternatively, the WHL may communicate with a wireless service provider to indicate that a wireless device is coupled to the WHL and the wireless service provider can adjust a rate structure associated with the wireless device and convey the adjusted rate plan to the WHL.

In initiating calls through the WHL, the WHL can use features associated with the media determined to be used for the call. For example, if the call is to be placed using a wireless phone, then speed-dialing features associated with that phone may be used even if the call is placed via a landline phone without such speed-dialing features.

At stage 308, the WHL routes incoming calls. For incoming PSTN calls, the WHL receives a destination device ID and routes the call appropriately. The WHL at least initially routes the call to the device corresponding to the destination device ID. If that device is unavailable, then the WHL may route the call to other devices associated with the WHL if the WHL is set up for forwarding, e.g., for one-number-find-me operation. Incoming calls received by a wireless device coupled to the WHL are routed to the standard phone extension(s) or another wireless phone based on predetermined associations of wireless device to extension/wireless phone. Incoming calls include calls received by a wireless device while not coupled to a WHL that are transferred to the WHL upon the wireless device becoming coupled to the WHL.

At stage 310, for incoming or outgoing calls, once the call is established, features associated with the communication devices or media used for the call may be provided to the user. For example, a call that comes through a wireless device to a landline phone may be provided with call waiting capability if the wireless device has this service even though the landline connection(s), if any exist, to the WHL does(do) not.

Other embodiments are within the scope of the invention. For example, other numbers of (more or less) trunk lines, analog extensions, cellular phone connections, and/or wire-line connections than those shown may be used and connected to wireless home loop systems. The amounts of these features shown are exemplary and not limiting. Also, while the description discussed cellular phones and associated networks, other forms of wireless mobile phones, and associated networks, are within the scope of the invention. Further, due to the nature of software, functions described above can be implemented using software, hardware, firmware, hardwiring, or combinations of any of these. The programming commands for the administration software module 112 may be different, e.g., of different format, than as described. Features implementing functions may also be physically located at various positions, including being distributed such that portions of functions are implemented at different physical locations.

What is claimed is:

1. A switching system for coupling a telecommunications device to a wireless network or a wireline network, the system comprising:
a wireless telecommunication interface configured to couple to a wireless telecommunications device configured to transfer data to and from a wireless telecommunications network;
a wireline phone interface configured to couple to a wireline-network phone;
a wireline network interface configured to couple to a wireline phone network;
a switching mechanism configured to selectively couple the wireline-network phone interface to the wireless telecommunication interface or to the wireline network interface; and
a controller coupled to the switching mechanism and configured to control the selective coupling effected by the switching mechanism.

2. The system of claim 1 wherein the controller is configured to control the switching mechanism in accordance with at least one of a wireless rate structure associated with the wireless telecommunication device and a wireline rate structure associated with the wireline phone network.

3. The system of claim 2 wherein the controller is configured to control the selective coupling of the switching mechanism depending on which coupling will likely yield a cheaper effective rate for a call being sent from the wireline-network phone.

4. The system of claim 3 wherein the controller is configured to control the selective coupling of the switching mechanism depending on at least one of instantaneous rates associated with the wireless telecommunications device and the wireline-network phone, whether the call is local or long distance, to where the call is directed, the rate structures, typical amounts of call minutes from the wireless telecommunication device, and typical amounts of call minutes from the wireline-network phone.

5. The system of claim 4 wherein the rate structures are affected by at least one of amounts of free minutes, time of day, and day of week.

6. The system of claim 3 wherein the effective rate for a call is a present rate.

7. The system of claim 3 wherein the effective rate for a call is an average rate.

8. The system of claim 1 further comprising another wireless telecommunication interface configured to couple to another wireless telecommunications device, wherein the switching mechanism is configured to selectively couple the wireline phone interface to the wireless telecommunication interface, the another wireless telecommunication interface, or to the wireline network interface.

9. The system of claim 1 further comprising at least another wireline phone interface configured to couple to another wireline-network phone, wherein the switching mechanism is configured to selectively couple the wireline phone interface or the at least another wireline phone interface to the wireless telecommunication interface or to the wireline network interface.

10. The system of claim 9 wherein the at least another wireline phone interface comprises seven wireline phone interfaces.

11. The system of claim 1 further comprising another wireline network interface configured to couple to the wireline phone network, wherein the switching mechanism is configured to selectively couple the wireline phone interface to the wireless telecommunication interface, to the wireline network interface, or to the another wireline network interface.

12. The system of claim 1 wherein the wireline phone interface is a first wireline phone interface, and the wireline network interface is a first wireline network interface, the system further comprising:
a plurality of second wireline phone interfaces configured to couple to a plurality of wireline-network phones; and
a second wireline network interface configured to couple to the wireline phone network;
wherein the switching mechanism is configured to selectively couple at least one of the second wireline phone interfaces to the second wireline network interface.

13. The system of claim 1 wherein the wireless telecommunication interface is configured to wirelessly couple to the wireless telecommunications device.

14. The system of claim 13 wherein the wireless telecommunication interface is configured to wirelessly communicate with the wireless telecommunications device according to a short-range wireless communication protocol.

15. The system of claim 14 wherein the wireless protocol is the Bluetooth® protocol.

16. The system of claim 1 further comprising an inter-system communication interface configured to couple to and communicate with another switching system as recited in claim 1 and further including another inter-system communication interface.

17. The system of claim 1 wherein the wireless telecommunications device is a mobile phone.

18. A method of providing mobile communication service, the method comprising:
providing wireless communication capacity for a wireless communication device, the communication capacity associated with a first rate structure for communication with the wireless communication device;
determining that the wireless communication device is near a stationary base unit configured to communicate with the wireless device; and
adjusting the rate structure associated with the wireless device to a second rate structure that is different than the first rate structure.

19. The method of claim 18 wherein the determining includes receiving an indication of proximity of the wireless device to the relatively-stationary base unit from the base unit.

20. The method of claim 18 wherein the determining includes receiving an indication of proximity of the wireless device to the relatively-stationary base unit from the wireless device.

21. The method of claim 18 wherein the second rate structure more closely resembles a rate structure associated with a wireline service rate structure than the first rate structure.

22. The method of claim 18 further comprising redirecting a call coming into the wireless device through a wireline network to a wireline phone connected to the base unit.

23. A system for coupling a wireline phone to a mobile-phone network, the system comprising:
a mobile-phone interface configured to couple to a mobile phone and to transfer information between the mobile-phone interface and the mobile phone according to a mobile-phone protocol; and
a wireline-phone interface coupled to the mobile-phone interface and configured to couple to a wireline-network phone and to transfer information between the wireline-phone interface and the wireline-network phone according to a wireline-phone protocol;
whereby a call can be made from the wireline-network phone connected to the wireline-interface through a mobile-phone network associated with the mobile phone connected to the mobile-phone interface.

24. The system of claim 23 further comprising:
a mobile phone coupled to the mobile-phone interface; and
a wireline phone coupled to the wireline-phone interface.

25. A telephone interface system capable of coupling to a plurality of wireline telephone extensions independently, capable of coupling to a wireline telecommunications network through a plurality of independent connections, and capable of independently coupling to a plurality of mobile telephones associated with at least one mobile-phone network, the system providing connection capability for calls to be completed between wireline extensions through the system, and the system providing connection capability for calls to be completed through the system between a wireline extension connected to the system and at least one of the mobile telephones connected to the system.

26. The system of claim 25 wherein the system is capable of coupling to at least one of the mobile phones wirelessly.

27. The system of claim 26 wherein the system is capable of coupling to at least one of the mobile phones wirelessly in accordance with a short-range wireless protocol.

28. The system of claim 25 further configured to selectively couple at least one wireline extension to at least one of the wireline network and at least one mobile telephone.

29. The system of claim 25 further configured to couple to another system according to claim 25.

30. The system of claim 29 configured to be capable of coupling a connection from the system to an extension, the wireline telecommunications network, or a mobile telephone, through the another system to an extension, a wireline telecommunications network, or a mobile telephone coupled to the another system.
